(19) United States
(12) Patent Application Publication
(10) Pub. No.: US 2009/0016844 A1
(43) Pub. Date: Jan. 15, 2009

(54) Positioning fixture for screws and/or nuts

(75) Inventor: Jurgen Dietmeier, Hausach (DE)

Correspondence Address: THE NATH LAW GROUP, 112 South West Street, Alexandria, VA, 22314, US

(73) Assignee: VEGA GRIESHABER KG, Wolfach (DE)

(21) Appl. No.: 12/216,546

(22) Filed: Jul. 7, 2008

Related U.S. Application Data
(60) Provisional application No. 60/929,666, filed on Jul. 9, 2007.

(30) Foreign Application Priority Data
Jul. 9, 2007 (DE) 10 2007 031 991.8

(51) Int. Cl. F16B 39/10

(52) U.S. Cl. 411/120

(57) ABSTRACT

The invention relates to a fixation device (1) for screws/bolts and/or nuts (2) comprising an outer profile (4) having multiple edges, wherein the fixation device (1) is fitted in a form-locking manner to at least two sides (15) of the outer profile (4) and is securable in a form-locking manner to the outer profile (4) by means of a fastening element (5).

The invention relates to a fixation device for bolts/screws and/or nuts comprising an outer profile having multiple edges.

In particular in areas in which screwed connections are exposed to vibrations or other forces acting from external sources that can cause the screwed connection to release or loosen, there is a need for a reliable locking means to prevent unscrewing or loosening of the screw/bolt.

An approach is known from the art wherein screwed connections are secured against unscrewing by means of adhesive bonding. For these screwed connections, adhesive bonding is effected either directly on the screw thread, or between the screw/bolt head and a stationary component. While this type of adhesive bonding ensures reliable protection against unscrewing, it does produce a stationary connection in which, after the screwed connection has been released, another securing action by adhesive bonding can be implemented only after the contact surfaces have again been cleaned. Another disadvantageous aspect is that if the adhesive is too strong or the application of the adhesive covers too large an area, the screwed connection locked thereby can no longer be released.

In the field of releasable screwed connections, in particular in the field of electrical connections, it is desirable, for example, to reliably secure freely rotating nuts on electrical connections against unscrewing and simultaneously not limit the releasability of such a screwed connection.

The problem to be solved by the invention is to provide a fixation device for screws/bolts and/or nuts that offers reliable protection against unscrewing yet at the same time does not limit the releasability of the screwed connection.

The problem is solved by a fixation device having the features of claim 1.

What is proposed is a fixation device for screws/bolts and/or nuts comprising an outer profile having multiple edges, wherein the fixation device is fitted on at least two sides of the outer profile and is fixable to the outer profile in a form-locking manner by means of a fastening element. This type of fixation device has the advantage that fixation of a screw/bolt and/or nut is effected using a fastening element fitted in a form-locking manner to the outer profile of the screw/bolt and/or nut, with the result that direct interference with the screwed connection on the thread and/or between the screw/bolt head, or the nut and a stationary component can be avoided.

Advantageously, the fixation device is designed as a lateral swing-away bowed clamp with a fastening element in the form of a locking screw, wherein the locking screw is secured against loosening by lock washers. This design of the fixation device has the advantage that it can be easily removed for assembly purposes, yet at the same time provide reliable protection against unscrewing. Another advantage is the fact that a lateral swing-away bowed clamp does not have to be completely removed in order to release the screwed connection, but instead enables the screw/bolt and/or nut to be released by a swiveling motion away from the screw/bolt section.

In a preferred embodiment, the bowed clamp has a circular-arc-shaped groove by which the bowed clamp can be fixed by means of the locking screw. The bowed clamp is advantageously fabricated out of metal or plastic. Having a circular-arc-shaped groove in the bowed clamp enables the locking screw to be fixed at different positions in the groove, thereby allowing the bowed clamp orientation to be adjusted to the turn-in position of the screw/bolt and/or nut. Depending on specific requirements, the bowed clamp can be fabricated out of metal or plastic.

In a preferred embodiment of the fixation device, one angle between two sides of the bowed clamp fitted in a form-locking manner measures 120°. A fixation device so designed is fitted in a form-locking manner to hexagonal-head bolts.

Use of this type of fixation device is especially advantageous in a device for measuring fill levels. The advantages of the invention are especially useful in this area of application since, for example, vibrations often occur in ultrasound-based fill-level measuring devices that necessitate the use of a screw/bolt-locking means. Nevertheless, the capability of disassembly must also continue to be ensured in this area.

Further advantages of the invention are revealed in the following description of an exemplary embodiment and reference to the attached figures.

In the figures:

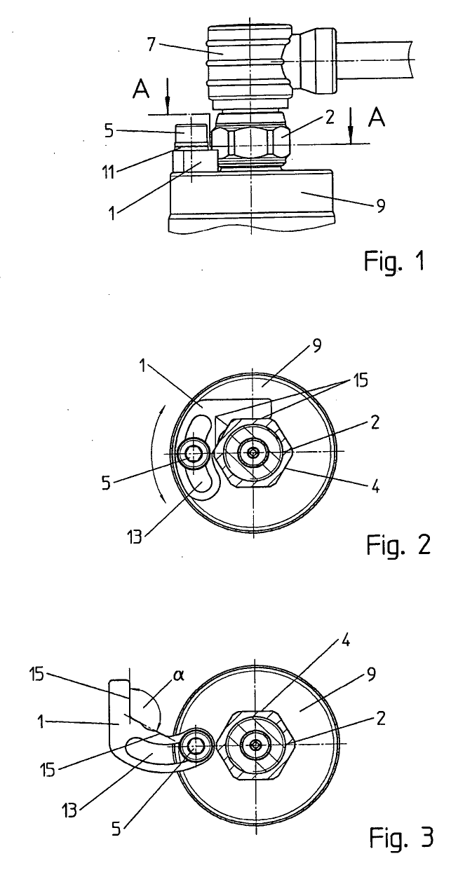

FIG. 1 illustrates a vibrating body of a fill-level measuring device having a screwed-together electrical plug connector and a fixation device according to the invention;

FIG. 2 is a top view of a section along line A-A of FIG. 1;

FIG. 3 provides the view of FIG. 3 with a lateral swing-away fixation device.

Unless otherwise indicated, identical reference notations denote identical or functionally-equivalent components.

FIG. 1 is a side view of a vibrating body 9 of a fill-level measuring device that is electrically contacted at its top side by means of a plug connector 7 secured by a nut 2. Nut 2 is secured against becoming unscrewed by a fixation device 1 that is connected in a rotationally-locked manner by a locking screw 5 to vibrating body 9. Locking screw 5 is in turn secured against becoming unscrewed by lock washers 11.

FIG. 2 illustrates a section along line A-A of FIG. 1. This view reveals the functional principle of the fixation device in an especially clear manner. Fixation device 1 has an arc-shaped body and has two sides 15 that are fitted in a form-locking manner to an outer profile 4 of nut 2. Furthermore, fixation device 1 has a circular-arc-shaped groove 13 by which fixation device 1 can be screwed on to vibrating body 9. Due to circular-arc-shaped groove 13, it is possible to move fixation device 1 into position relative to outer profile 4 of nut 2 in an always optimal fashion and to secure it by means of locking screw 5. A design of this type is useful in many areas since the end position of a nut is often not predictable. Having an arrangement for fixation element 1 in the screwed direction of locking screw 5 ensures that fixation device 1 is pressed even more tightly against outer profile 4 of nut 2 when locking screw 5 is screwed down.

FIG. 3 presents the view of FIG. 2 wherein the fixation device is shown in a lateral swing-away position. This is easy to achieve by releasing locking screw 5 such that nut 2 is essentially freely accessible, and in particular is easy to unscrew. What is revealed especially clearly in this view is that angle α between the two sides 15 of fixation device 1 measures 120° which corresponds to the angle between the sides of outer profile 4 of a hexagonal nut. An adaptation to fit other outer profiles, for example, polygonal or multipoint profiles is also conceivable.

### LIST OF REFERENCE NOTATIONS

1 fixation device/bowed clamp
2 screw/bolt/nut
4 outer profile
5 fastening element/locking screw
7 plug connector
9 vibrating body
11 lock washer
13 groove
15 side angle

1. Fixation device (1) for screws/bolts and/or nuts (2) comprising an outer profile (4) having multiple edges,
characterized in that the fixation device (1) is fitted in a form-locking manner to at least two sides (15) of the outer profile (4) and is securable in a form-locking and releasable manner to the outer profile (4) by means of a fastening element (5).

2. Fixation device (1) according to claim 1,
characterized in that the fixation device (1) is of a bowed-clamp design.

3. Fixation device (1) according claim 1,
characterized in that the fastening element (5) is in the form of a locking screw.

4. Fixation device (1) according to claim 1,
characterized in that the fastening element (5) is secured against releasing by lock washers (11).

5. Fixation device (1) according to claim 1,
characterized in that the fixation device (1) has a circular-arc-shaped groove (13).

6. Fixation device (1) according to claim 1,
characterized in that the fixation device (1) is fabricated out of metal.

7. Fixation device (1) according to claim 1,
characterized in that the fixation device (1) is fabricated out of plastic.

8. Fixation device (1) according to claim 1,
characterized in that an angle (α) between two sides (15) fitted in a form-locking manner is 120°.

9. Use of the fixation device (1) according to claim 1 in a fill-level measuring device.
